(19) United States
(12) Patent Application Publication
(10) Pub. No.: US 2018/0081175 A1
(43) Pub. Date: Mar. 22, 2018

(54) VISUAL FIELD ENHANCEMENT SYSTEM

(71) Applicant: Craig Hospital, Englewood, CO (US)

(72) Inventor: Thomas A. Politzer, Golden, CO (US)

(21) Appl. No.: 15/711,179

(22) Filed: Sep. 21, 2017

Related U.S. Application Data
(60) Provisional application No. 62/397,722, filed on Sep. 21, 2016.

(51) Int. Cl. G02B 27/01

(52) U.S. Cl. CPC G02B 27/017; G02B 2027/0178; G02B 2027/0123; G02B 27/0101

(57) ABSTRACT

A system and method of treating a visual limitation of a patient includes capturing images of a region that would not be readily viewable by the patient due to at least one of a visual or physical impairment of the patient using an imaging device supported in proximity to the patient. The images are then transmitted to a wearable screen positioned in front of an eye of the patient such that the patient can view the captured images on the wearable screen with the eye.

### CROSS-REFERENCE TO RELATED APPLICATIONS

The present application claims priority to U.S. Provisional Patent Application No. 62/397,722, which was filed on Sep. 21, 2016, and is entitled “Visual Field Enhancement System.” The contents of the above-mentioned patent application are hereby incorporated by reference in its entirety.

### FIELD OF THE INVENTION

The present invention pertains to systems and methods of compensating for acquired visual field loss.

### BACKGROUND OF THE INVENTION

Acquired visual field loss, regardless of etiology, causes significant impairments for the affected patient. Patients acquire hemianopic, quadranopic, or altitudinal loss from severe injury or disease. This results in a poorer quality of life with impairment for work, driving, ambulation, and most of the activities of daily living. The financial and social costs are tremendous.

There is a need in the art for affordable and effective devices, methods of treatment and methods of diagnosis that address acquired visual field loss.

### BRIEF SUMMARY OF THE INVENTION

In one embodiment of the present disclosure, a method of treating a visual limitation of a patient is provided. The method includes capturing images of a region that would not be readily viewable by the patient due to at least one of a visual or physical impairment of the patient using an imaging device supported in proximity to the patient. The imaging device may be, for example, a smartphone or a live-streaming video device. The images are then transmitted to a wearable screen positioned in front of an eye of the patient such that the patient can view the captured images on the wearable screen with the eye.

In one implementation, the method further includes coupling the wearable screen to a pair of eyeglasses or headwear such that the wearable screen is disposed within a peripheral region of the patient's field of vision. In another implementation, the method further includes coupling the imaging device to at least one of the patient, a garment or accessory worn by the patient, or an object in proximity to the patient such that the imaging device is directed towards the region that would not be readily viewable by the patient. The method may further include electrically coupling the imaging device to the wearable screen.

In another implementation, the method further includes identifying a modification to the region not readily viewable by the patient resulting in a modified region and transmitting second images to the wearable screen, the second images including the modified region, and transmitting the images to the wearable screen such that the patient can view the modified images on the wearable screen with the eye. In such implementations, identifying the modification to the region may include identifying at least one of an eye movement or a head movement of the patient. The images of the modified region may also be captured by the imaging device or a second imaging device in proximity of the patient.

In yet another implementation, the method may include detecting an object within the region that would not be readily viewable by the patient and providing a warning to the patient in response to detecting the object. The warning may be, for example, an audible warning, a visual warning displayed on the wearable screen, or a tactile warning.

In another embodiment of the present disclosure, a kit for providing images for visual field enhancement to a patient is provided. The kit includes a wearable screen configured to be worn by the patient and to be positioned in front of an eye of the patient such that the patient can view the wearable screen with the eye. The kit further includes instructions directed to configuration and calibration of the wearable screen, the instructions directing (1) the wearable screen to be positioned within a peripheral region of a field of view of the patient; and (2) an imaging device to be connected to the wearable screen and directed to a region that would not be readily viewable by the patient due to at least one of a visual or physical impairment of the patient. In certain implementations the kit may further include the imaging device.

In implementations of the present disclosure, the instructions may be, among other things, one of printed instructions included with the kit, electronic instructions stored within a memory of the wearable screen, or electronic instructions available for download over a network. The instructions may further direct the wearable screen to be coupled to at least one of the patient, a garment worn by the patient, or an accessory worn by the patient.

In yet another embodiment of the present disclosure, a visual field enhancement system is provided. The system includes a wearable screen configured to be worn by the patient and positioned in front of an eye of the patient such that the patient can view the wearable screen with the eye. The system further includes an imaging device electrically coupled to the video screen. The imaging device can be oriented to capture images of a region that would not be readily viewable by the patient due to at least one of a visual or physical impairment of the patient. The captured images of the region may then be transmitted to the video screen, which is positioned in front of the eye of the patient such that the patient can see the captured images on the video screen.

In certain implementations, the system may further include a mount coupled to the wearable screen and adapted to couple the wearable screen to at least one of the patient, a garment worn by the patient, or an accessory worn by the patient. The system may also include an imaging device mount coupled to the imaging device for mounting the imaging device in proximity to the patient. In certain implementations, the wearable screen and the imaging device may be integrated into a single assembly.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a schematic illustration of a visual field enhancement (VFE) system according to an embodiment of the present disclosure.

FIG. 2 is a block diagram of the VFE system of FIG. 1.

FIGS. 3A and 3B are front and side views, respectively, of a display device of the VFE system of FIG. 1 coupled to a pair of eyeglasses.

FIG. 4A is a plan view of an operational environment including a patient using the VFE system of FIG. 1.

FIG. 4B is a side view of a head of the patient wearing the display device of FIGS. 3A-3B.

FIG. 4C is a plan view of the operational environment of FIG. 4A including the patient implementing the VFE system with a wheelchair.

FIG. 5 is a plan view of a VFE system kit.

FIGS. 6A and 6B are plan views of an operational environment in which the patient is using the VFE system as configured to track and respond to movements of the patient's head.

FIG. 7 is a side view of a head of the patient wearing the display device of FIGS. 3A-3B with an eye tracker.

FIG. 8 is a plan view of an operational environment in which the patient is using the VFE system as configured to detect objects in proximity to the patient.

FIG. 9 is a flow chart illustrating a method of setup and initialization of a VFE system in accordance with the present disclosure.

FIG. 10 is a flow chart illustrating a method of modifying a region captured by an imaging device in response to movement of a patient.

FIG. 11 is an example computing system that may implement various systems and methods of the presently disclosed technology.

### DETAILED DESCRIPTION

The present disclosure is directed to systems and methods for enhancing a user's visual field. Such systems and methods may be used, for example, in the treatment of injuries and diseases that directly affect the visual system of a patient or that limit the mobility of a patient such that the patient's normal visual field is reduced or otherwise compromised.

Systems and methods disclosed herein generally include a wearable display device that is worn by the patient. An imaging device is communicatively coupled to the display device such that images captured by the imaging device are displayed to the patient via a screen of the wearable display device.

The wearable display device may be coupled to a body part of the patient or a garment or accessory (such as a hat or eyeglasses) worn by the patient. The wearable display device may also be adjustable such that the screen of the wearable display device may be positioned to be viewed by the patient. In certain implementations, for example, the display device may be placed within a peripheral region of the patient's visual field. By doing so, the patient may scan or otherwise glance at the screen without the screen obstructing the patient's primary vision.

The imaging device is positioned and oriented such that the imaging device captures images of the area for which the patient has limited vision. The imaging device may be a smartphone or live-streaming video device that is supported in proximity to the patient. In certain implementations, the imaging device may be coupled to the patient and, more specifically, one of a body part of the patient or a garment or accessory worn by the patient. In other implementations, the imaging device may instead be coupled to furniture or other objects in proximity to the patient. For example, the imaging device may be coupled to, among other things, a bed, a table, or a wheelchair used by the patient.

In certain implementations, the systems and methods disclosed herein further support dynamic adjustment of the region captured by the imaging device in response to movement of the patient's head and eyes. For example, in one implementation, an accelerometer or similar sensor is coupled to the patient and used to measure movements of the patient's head. Such measurements are then used to switch between multiple imaging devices, modify which portions of a wide angle image are displayed to the patient, and to perform similar operations directed to adjusting the images presented to the patient to reflect movement of the impaired region.

In light of the foregoing, the systems and methods disclosed herein may be used to at least partially restore or otherwise provide vision to a patient suffering from visual impairment due to injury or diseases of the patient's visual system or loss of mobility in a manner that is efficient and non-obtrusive to the patient's primary activities.

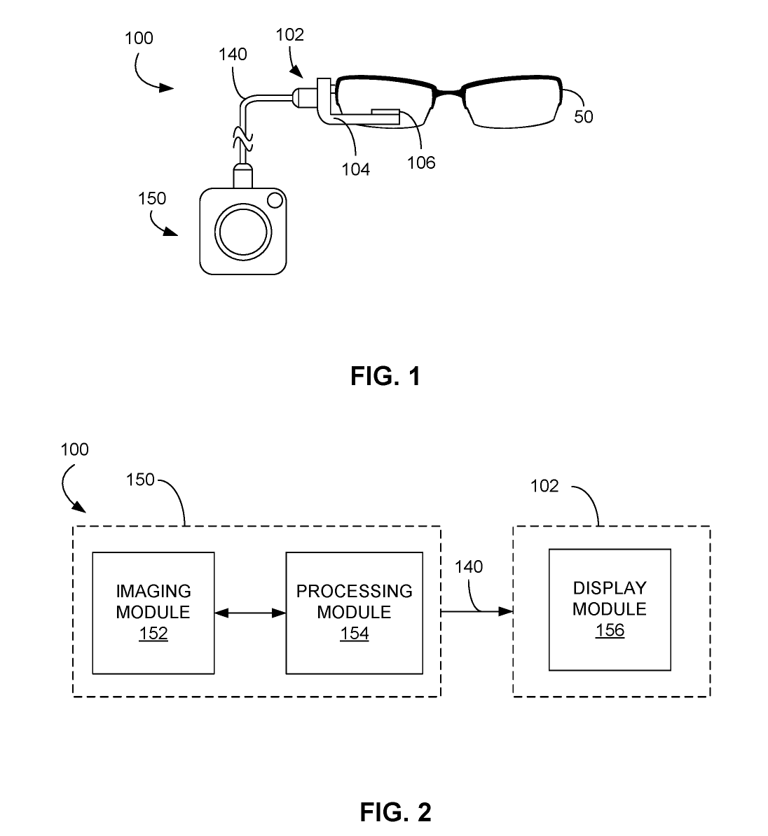

FIG. 1 is a schematic illustration of a visual field enhancement (VFE) system 100 according to an implementation of the present disclosure and FIG. 2 is a block diagram representation of the VFE system 100 of FIG. 1. The VFE system 100 includes a display device 102 including a frame 104 that supports a display 106. The VFE system 100 further includes an imaging device 150 that is electrically coupled to the display device 102, such as by a cable 140.

During use, each of the imaging device 150 and the display device 102 are worn by a patient. As illustrated in FIG. 1, for example, the display device 102 may be adapted to be coupled to and supported by a pair of eyeglasses 50 such that the display 106 is supported in front of the eyeglasses 50 within the peripheral vision of a patient wearing the eyeglasses 50 and display device 102. In other implementations, the display device 102 may instead be adapted to be coupled to and supported within the peripheral vision of the patient by accessories or garments other than eyeglasses. For example, and without limitation, such garments may include a hat or a headband to which the display device is coupled. In still other implementations, the display device 102 may be supported by a support, such as a harness or frame, worn by the patient.

During operation, the imaging device 150 is directed to an area of limited vision of the patient and captures images of the area. The images are then transmitted, such as by the cable 140, to the display device 102 and, more specifically, the display 106 of the display device 102 for presentation to the patient. The patient may then view the area of limited vision by redirecting their gaze to the display 106. By doing so, the VFE system 100 effectively extends the field of vision of the patient to include the area of limited vision.

The imaging device 150 may be, but is not limited to, a digital video camera, a camera of a mobile computing device (including smartphones, such as an Apple iPhone®), or live-streaming type of video device (such as, for example, a GoPro® camera). In certain implementations, the imaging device 150 may be worn or otherwise coupled to the patient. For example, the patient may place the imaging device 150 in a pocket or couple the imaging device 150 to his or her shirt, belt, or other garment using a clip or mount. In other implementations, the imaging device 150 may be coupled to and supported by a structure in proximity to the patient. Such structures may include, without limitation, a wheelchair; a chair; a bed frame; an interior structure of a vehicle; or a table, desk, or similar surface. In still other implementations, the imaging device 150 may be integrated with the display device 102 into a single device worn by the patient in a similar manner as describe above with respect to the display device.

As illustrated in FIG. 1, the display device 102 may be directly coupled to the imaging device 150 by the cable 140. The cable 140 may be any suitable cable type capable of connecting to each of the display device 102 and the imaging device 150 and transmitting images captured by the imaging device 150 for presentation on the display 106. In certain implementations, for example, the cable 140 may be a Universal Serial Bus (USB), High Definition Multimedia Interface (HDMI), or similar cable extending between corresponding interfaces of the imaging device 150 and the display device 102. In certain implementations, a wired connection between the display device 102 may reduce latency between capture and display of images and may improve overall battery life of the VFE system 100.

Regarding batteries, each of the display device 102 and the imaging device 150 may include batteries and corresponding ports for recharging the batteries. For example, the display device 102 may include a mini-USB or similar port that may be used to connect the display device 102 to a power outlet for charging. In certain implementations, the power port and a port enabling connection between the display device 102 and the imaging device 150 are separate such that the display device 102 or the imaging device 150 may be charged while the VFE system 100 is in use.

Although illustrated in FIG. 1 as being coupled by the cable 140, in other implementations, the imaging device 150 may be adapted to communicate with the display device 102 and transmit images to the display device 102 wirelessly. For example, each of the imaging device 150 and the display device 102 may be configured to communicate using one or more wireless protocols including, without limitation, Bluetooth, Zigbee, near-field communication, Wi-Fi, and similar wireless protocols.

As illustrated in FIG. 2, the imaging device 150 may generally include each of an imaging module 152 and a processing module 154. The imaging module 152 may include one or both of software and hardware components adapted to capture and process image data. For example, the imaging module 152 may include, without limitation, one or more of an imaging sensor for capturing image data, a digital image processor for processing image data, and one or more memories for storing image data. The processing module 154 may include one or more processors and one or more memories coupled to the processors. The one or more memories may be used to store image data captured by the imaging module 152 and may further store instructions executable by the one or more processors. Such instructions may be adapted to cause the processor to, among other things, send and receive commands and data to the imaging module 152, process images received from the imaging module 152, and coordinate transmission and receipt of data (including image data) to the display device 102. Upon receiving image data from the imaging device 150, such as over the cable 140, the display device 102 may render and present the image data using a display module 156 adapted to control the display 106 of the display device 102. Although not illustrated in FIG. 2, the display device 102 may further include one or more processors, memories, and similar components adapted to store and execute instructions corresponding to various functions of the display device 102 as described in this disclosure.

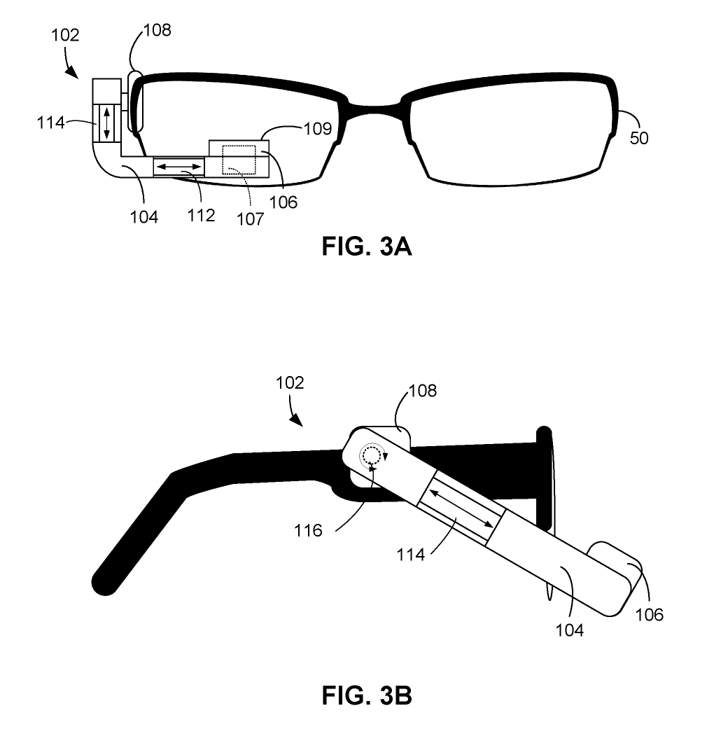

FIGS. 3A and 3B are front and side views, respectively, of the display device 102 coupled to the eyeglasses 50. The display device 102 may be coupled to eyeglasses 50 or other garments or accessories worn by the patient. To do so, the display device 102 may include a mount 108 adapted to support the display device 102 on the eyeglasses 50. As further illustrated in FIGS. 3A-3B, the display device 102 includes a frame 104 shaped to extend from the mount 108 to dispose the display 106 in front of the eyeglasses 50.

The display 106 may include a miniature, high definition screen 107 and a carrier 109 in which the screen 107 is disposed. In certain implementations, the computer screen 107 may measure approximately 9 mm by approximately 9 mm and the carrier 109 may measure approximately 20 mm wide by approximately 16 mm tall. As depicted in FIG. 3A, the screen 107 and the carrier 109 may be attached to the frame 104 and the frame 104 may bend to a nearly 90-degree angle.

In general, the position of the display 106 in front of the eyeglasses 50 corresponds to a position within the peripheral vision of the patient. To facilitate placement of the display 106, the display device 102 may allow a patient or physician to perform various adjustment. For example, the display device 102 includes each of a first section 112, a second section 114, and a pivot 116 for adjusting the position of the display 106. The pivot 116 enables rotation of the frame about the pivot 116, the first section 112 generally allows for medial and lateral adjustment of the display 106, while the second section 114 enables adjustment of the display toward or away from the patient.

Although described herein as being positioned within the patient's peripheral vision, the display 106 may be positioned in front of either eye and at any suitable elevation to accommodate the patient's particular impairment. For example, in certain cases when the patient has limited vision in only one eye, the display 106 may be placed within a region of normal vision of the impaired eye or may be placed in front of the patient′ other eye. The display 106 may also be placed at any distance, elevation or medial/lateral position relative to the patient that is best suited to the patient's particular impairment. For example, in certain cases, a patient's impairment may result in the best placement of the display device 106 being directly in front of one of the patient's eye even though such placement may be unnecessarily obstructive for a patient whose peripheral vision is substantially intact. Accordingly, to the extent this disclosure references specific placements of the display device 106, such placements are intended only as examples and should not be considered limiting.

The mount 108 may include a magnetic or other coupling such that the frame 104 may be readily attached and detached from the mount 108. For example, the pivot 116 may be a magnet adapted to mate with and couple with a corresponding magnet or metallic plate disposed within the frame 104. In such implementations, the frame 104 may be readily detachable from the mount 108 such that a patient may detach the frame 104 when the patient does not need to use the display device 102.

In one embodiment, the display device 102 may be may employ an off-the-shelf high definition device such as, for example, those offered by Vufine of 1202 Kifer Road, Sunnyvale Calif. 94086.

A summary of technical specifications for an example display device 102 according to the present disclosure is provided in Table 1.

TABLE 1
Example Display Device Specifications

| | |
|---|---|
| Unit Weight | 26 g |
| Battery Life | Approximately 90 minutes |
| Video Input | 720p HDMI |
| Charging Input | 5 V Micro USB |
| Display Type | LCOS qHD 960 × 540 |
| Brightness | 220 cd/m² |
| Contrast Ratio | 150:1 |
| Refresh Rate | 60 Hz |
| Optics Focal Length | 13.59 mm (0.54″) |

Although the implementation of the display device 104 shown in FIGS. 3A and 3B places the screen 107 in front of the patient's right eye, in other embodiments the display device 102 may instead be configured to be positioned in front of the patient's left eye. In certain implementations, the same display device 102 may be mounted in either a left-eye or right-eye configuration. In such implementations, the display device 102 may be adapted to invert images on the screen 107 to reflect the proper orientation of the display device 102. Such inversion may be in response to an input provided by the patient or may be automatic based on, for example, a measurement taken from an accelerometer or similar sensor that may be used to determine the orientation of the display device 102. Where both eyes can benefit from use of a display device, certain embodiments may employ a pair of display devices 102 with one display device positioned in front of the patient's right eye and the other display device positioned in front of the patient's left eye.

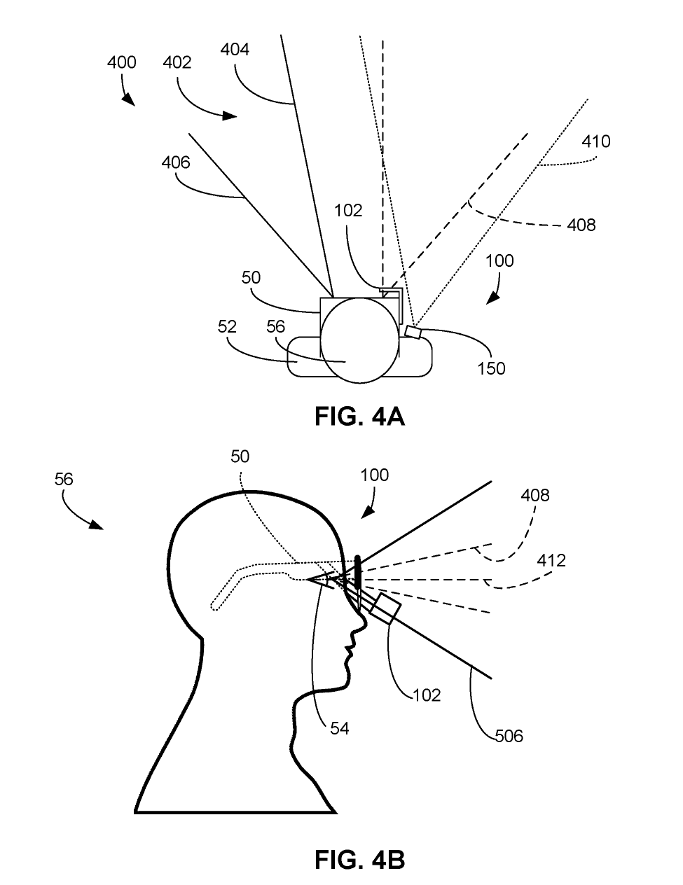

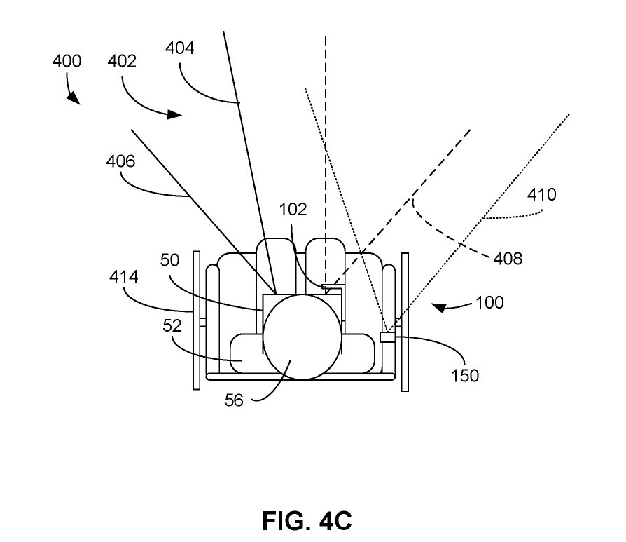

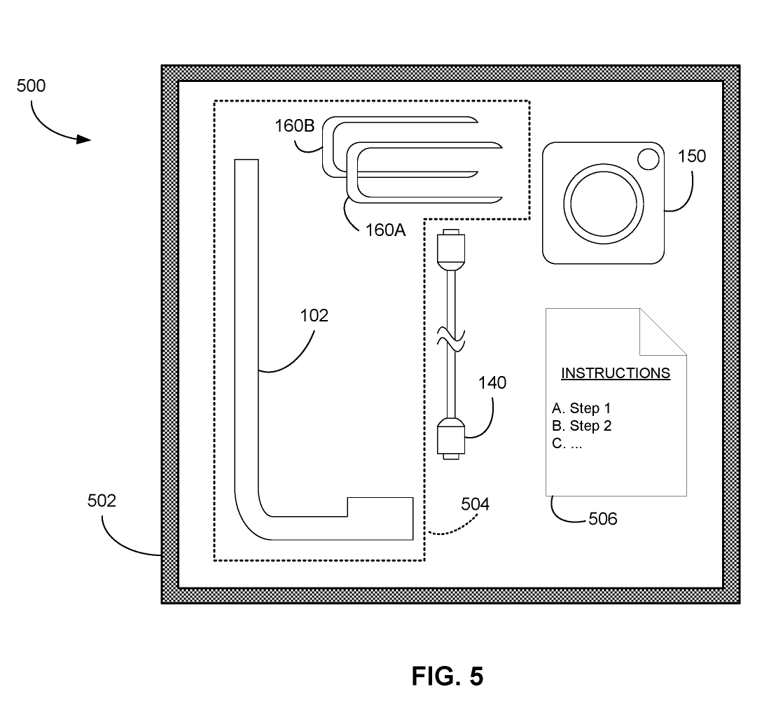

FIGS. 4A and 4B illustrate the display device 102 as worn by a patient 52. In particular, FIG. 4A is a schematic illustration of an environment 400 in which a patient 52 is wearing each of the display device 102 and the imaging device 150. FIG. 4B is a profile view of the patient's head 56 with the patient 52 wearing the display device 102. To more clearly illustrate the eye 54 of the patient 52, the eyeglasses 50 and the display device 102 are shown as partially transparent in FIG. 4B.

As illustrated in FIG. 4A, the patient 52 generally has a patient field of view 402 including a primary field of view 404 and a peripheral field of view 406. The patient field of view 402 further includes a limited field of view 408 corresponding to an area not generally visible by the patient 52 and may be the result of, among other things, impairment to the patient's vision or mobility. The imaging device 150 generally has an imaging field 410 and is coupled to the patient 52 such that the imaging field of view 410 at least partially overlaps the limited field of view 408 of the patient 52.

As illustrated in FIG. 4B, the display device 102 is worn by the patient 52 such that the screen 107 of the display device 102 is placed in a position to be viewed in front of the patient's eye 54. The precise position of the screen 107 may be determined by clinical evaluation. However, in general, the position of the screen 107 generally corresponds to a region of the patient's peripheral vision such that the patient 52 may see images displayed on the screen 107 in their peripheral vision and, if necessary, avert their gaze to the screen 107 to place the screen 107 within their primary field of view 404.

In one implementation, the display 106 of the display device 102 is placed slightly below a center-line 412 of the patient's gaze such that the patient 52 can look over the display 106 of the display device 102 yet still be aware of the display in a portion of their intact peripheral field of vision. Such awareness functions as a first cue to the patient 52 to view into the screen 107. Placement of the screen 107 below the center-line 412 also enables a patient to operate and make use of the display device 102 in a similar manner as a bifocal in eyeglasses. As such, the patient can easily make a downward saccadic movement to fully view the image shown in the screen 107. Since peripheral vision is most sensitive to motion, movement or changes in the image displayed on the screen 107 acts as a second cue from the VFE system 100 to the patient 52 to look into the screen 107 of the display device 102.

FIG. 4C illustrates the environment 400 with the patient 52 using an alternative setup of the VFE system 100 of FIG. 1. Similar to FIG. 4A, the patient 52 generally has a patient field of view 402 including a primary field of view 404 and a peripheral field of view 406. The patient field of view 402 further includes a limited field of view 408 corresponding to an area not generally visible by the patient 52 and may be the result of, among other things, impairment to the patient's vision or mobility. In contrast to the arrangement of FIG. 4A, the patient 52 as illustrated in FIG. 4C is seated in a wheelchair 414 and the imaging device 150 is coupled to the wheelchair 414. The imaging device 150, which generally has an imaging field 410, is coupled to the wheelchair such that the imaging field of view 410 at least partially overlaps the limited field of view 408 of the patient 52.

In light of the foregoing, a patient may be trained to use the VFE system 100 disclosed herein and, as a result, supplement his or her vision to account for lost portions of the patient's visual field and/or lack of mobility of the patient that precludes movement of the patient's body or head to shift the patient's field of vision. Patients may be trained to use the VFE system 100 by, for example, a physician or occupational or physical therapists. When fully trained, the patient should be able to (i) notice visual motion displayed on the screen 107 of the display device 102 while the patient is attending to a primary task at hand; (ii) scan quickly and briefly to the screen 107 of the display device 102 to see the displayed images; (iii) return his or her gaze back to the primary task or shift their vision to the objects presented on the screen 107; and (iv) quickly process the visual information presented using the screen 107 of the display device 102 and act according.

In some embodiments, the VFE system 100 may be provided in the form of a kit 500. Such a kit 500 is shown in FIG. 500. The kit 500 may include the VFE system 100 enclosed in a package 502. In some implementations, components included with the kit 500 may be contained in individual packages that are not held within the package 502. Alternatively, the components of the kit 500 may be contained in a single common package or in any combination of packages and combination of tool, implants and anchor members.

In certain implementations, the kit 500 may be a basic kit (as indicated by outline 504) including the display device 102 and one or more mounts 160A, 160B or similar support devices for coupling the display device 102 to, among other things, the patient, furniture, or a wheelchair. The kit 500 may be expanded to include one or more additional items including, without limitation, the imaging device 150 and the cable 140 for coupling the imaging device 150 to the display device 102. Additional components that may be included with the kit 500 include, without limitation, one or more of a power cable, one or more batteries for the display device 102 or the imaging device 150, and accessories (such as a hat, eyeglasses, etc.) to which the display device 102 may be coupled.

The kit 500 may further include instructions 506 that lay out the steps of one or more of setting up, calibrating, and using the VFE system 100. Such instructions 506 may be contained within the package 502. Alternatively, the instructions 506 may be adhered or otherwise attached to an exterior surface of the package 502. Alternatively, the instructions 506 may be simply provided separately such as, for example, being shipped loose with the rest of the kit 500, emailed, available for download at a manufacturer website, provided via a manufacture offered training seminar program, or provided by a physician to the patient. The instructions 506 may also be stored in a memory of one or both of the display device 102 and the imaging device 150. In some implementations, such instructions may be stored in memory in the form of an executable file designed to walk one or both of the patient and his or her physician through the process of configuring and calibrating the VFE system 100. In such implementations, the executable file may be initiated upon initial startup of the VFE system 100 or may be otherwise accessed and run by the patient or his or her physician.

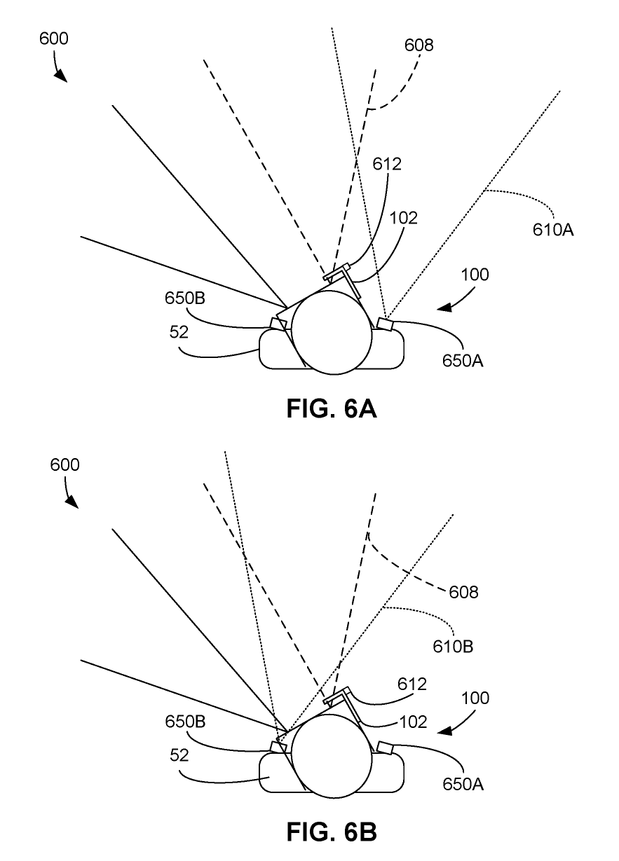

FIGS. 6A and 6B illustrate an environment 600 in which an alternative implementation of the VFE system 100 is being used by the patient 52. During use of the VFE system 100, the patient 52 may move or otherwise change direction of their gaze. Accordingly, in certain implementations of the present disclosure, one or more of the patient's head position or gaze direction may be tracked to determine changes in the patient's field of view and, specifically, changes in the area corresponding to the limited field of view of the patient. In response to such changes, the VFE system 100 may modify one or more of its operating parameters in order to shift the direction from which images are captured for display on the screen of the display device 102.

As shown in FIGS. 6A and 6B, in certain implementations the patient 52 may wear each of a first imaging device 650A and a second imaging device 650B that are coupled to the patient 52 such that each of the imaging devices 650A, 650B capture a different imaging field of view. For purposes of this example, the first imaging device 650A is oriented similar to the imaging device 150 shown in FIG. 4A. Accordingly, the first imaging device 650A has a first imaging field of view 610A that is able to capture images of the patient's limited field of view 408 when the patient 52 is looking in a substantially forward direction, as shown in FIG. 4A.

Referring back to FIGS. 6A and 6B, when the patient 52 turns their head or otherwise changes the direction of his or her gaze, a new limited field of view 608 results. As shown in FIG. 6A, the first imaging field of view 610A does not capture a significant portion of the new limited field of view 608. In such instances, the VFE system 100 may switch to receiving images from the second imaging device 650B which, as shown in FIG. 6B has a second imaging field of view 610B that substantially overlaps the new limited field of view 608.

The VFE system 100 may include any number of additional imaging devices, each of which are adapted to capture images within the patient's limited field of view as the patient 52 moves his or her head or otherwise changes direction of their gaze. In other implementations, one or more of the imaging device may include a wide angle or similar lens adapted to capture a broad imaging field of view. The imaging device and/or the display device may then selectively display portions of the broad imaging field of view based on the position of the patient's head or direction of their gaze.

Multiple imaging systems or multiple images derived from a single imaging system may also be provided to the user simultaneously. For example, a first image from a first imaging device and a second image from a second imaging device may be presented by the display device in a picture-in-picture arrangement in which one of the images is a primary image and the other is a secondary image embedded within a portion of the primary image. The patient may then switch which image is considered the primary image and/or the VFE system 100 may automatically determine which image is the primary image based, for example, on the position of the patient's head or the direction of his or her gaze.

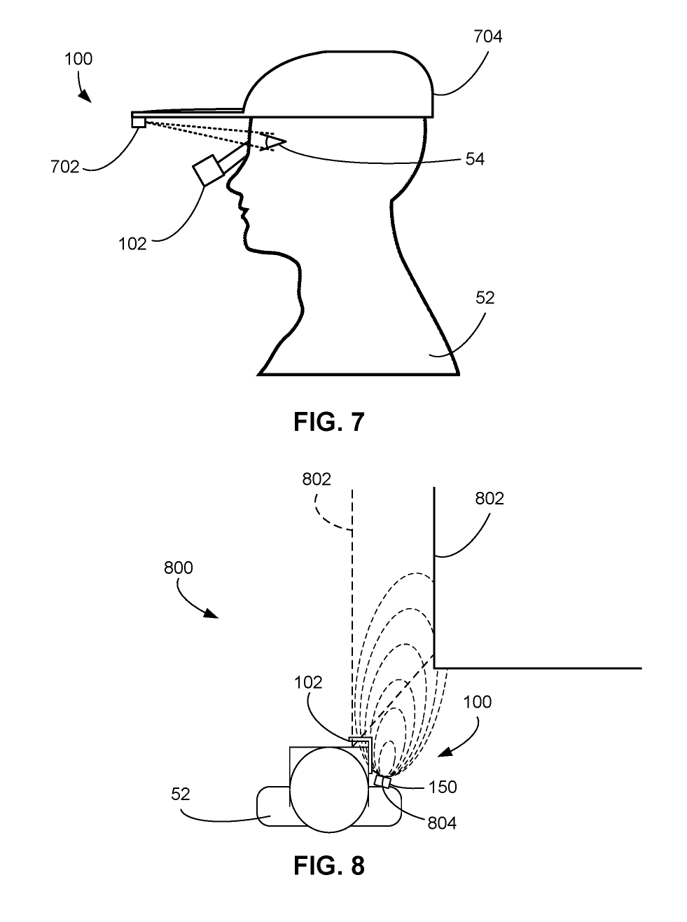

The head position or direction of the patient's gaze may be measured in various ways. For example, as illustrated in FIGS. 6A and 6B, a sensor, such as an accelerometer 612, may be coupled to the display device 102 and may provide measurements from which the head position of the patient 52 may be determined. Various sensors may also be used to measure and determine the patient's gaze. For example, as illustrated in FIG. 7, the VFE system 100 may include an eye tracking sensor 702 worn by the patient 52, such as on a hat 704. The eye tracking sensor 702 may use infrared or similar detection methods for determining the position of the patient's eye 54.

The display device 102 of the VFE system 100 may further include one or more actuators adapted to dynamically change the position and/or orientation of sections of the frame 104 such that the screen 107 remains within the patient's peripheral vision as the patient's eyes or head moves. For example, and referring to FIGS. 3A and 3B, one or more actuators may be coupled to the first frame section 112 or the second frame such that the first frame section 112 or the second frame section 114 may be extended or retracted in response to movement of the patient. Similarly, an actuator may be coupled to the pivot 116 such that the frame 104 may be rotated about the pivot 16 in response to movement by the patient 52.

FIG. 8 illustrates another environment 800 illustrating yet another implementation of the VFE system 100. As illustrated, the environment includes each of the patient 52 and an obstacle 802. The obstacle 802 may be any object that may impede the movement of the patient 52 or that may otherwise block or contact the patient 52 as the patient 52 moves through the environment.

To facilitate navigation by the patient through the environment 800, the VFE system 100 may further include a proximity sensing device 804 directed to identifying objects that enter the patient's limited field of view 808. The proximity sensing device 804 may include, without limitation, one or more of a sonar device, a laser range finding device, a motion detector, or any other device adapted to identify the location of an object near the patient 52. In response to detecting an object, the VFE system 100 may issue a warning to the patient 52. Such a warning may include, without limitation, one or more of an audible warning, a visual warning delivered through the display device 102 of the VFE system 100, a tactile warning (such as a vibration) or any suitable warning for indicating that an object has entered the patient's limited field of view 808.

In certain implementations, additional environmental information may be provided to the VFE system 100 through other sensors coupled to or incorporated into the display device 102 and/or the imaging device 150. For example, in implementations in which a smartphone is used as the imaging device 150, one or more sensors and modules of the smartphone may be used to facilitate movement and other tasks performed by the patient 52. Such sensors and modules may include a global positioning system (GPS) module or similar geolocation device capable of identifying the current position of the patient 52 and determining the position of the patient 52 with respect to known positions of other objects in the vicinity of the patient 52. In addition to providing warnings to the patient 52, such sensors may also be used to provide additional information via the display device 102, such as directions or similar navigational aids.

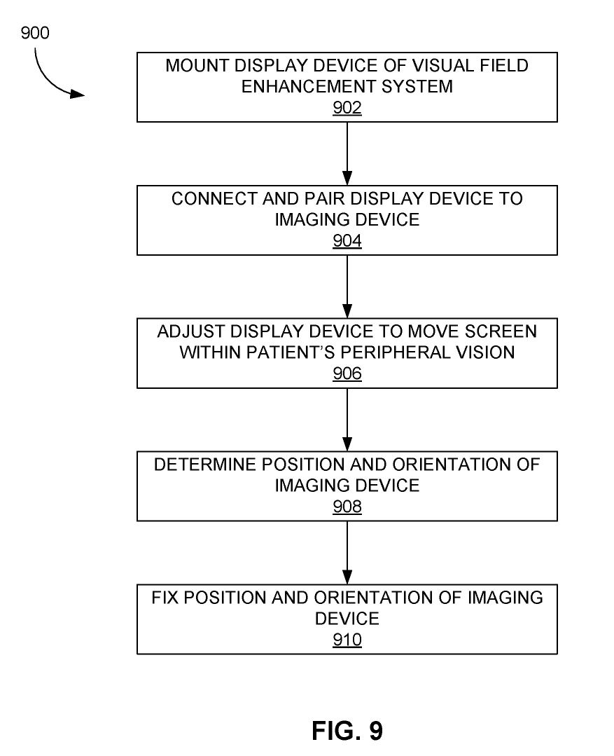

FIG. 9 is a flow chart illustrating a method 900 for initializing a VFE system in accordance with the present disclosure. The method 900 generally includes mounting the components of the VFE system such that the display device of the VFE is within the appropriate area of the patient's vision and establishing a suitable direction for an imaging device of the VFE system such that the imaging device captures images of an area for which the patient has limited sight.

With reference to the VFE system 100 of FIGS. 1-3B, the method 900 includes, at a first operation 902, mounting the display device 102. As previously described, such mounting may include coupling a mount, such as the mount 108, to eyeglasses, a hat, or a similar garment or accessory and coupling the display device 102 to the mount 108. In certain implementations, coupling of the display device 102 to the patient 52 (e.g., to eyeglasses or a hat worn by the patient 52) may be withheld until after an initial period of familiarization by the patient 52.

At operation 904, the display device 102 is paired with the imaging device 150 of the VFE system 100. Such pairing may include, among other things, one of physically and wirelessly connecting the display device 102 to the imaging device 150 and establishing communication between the display device 102 and the imaging device 150. In addition to establishing a connection, pairing may further include initiating an application or similar software on one of the display device 102 and the imaging device 150 directed to controlling and operating the VFE system 100 in accordance with this disclosure.

At operation 906 the display device 102 is adjusted such that the screen 107 of the display device 102 is disposed within a peripheral region of the patient's field of view. Such adjustment may include extending, retracting, rotation, or otherwise manipulating sections of the frame 104 of the display device 102 such that the screen 107 is properly placed outside of the patient's primary field of vision.

The foregoing steps may be conducted by a physician or therapist as a clinical process in which the patient 52 is shown the above-described VFE system 100. The VFE system may then activated and the patient 52 may hold the display device 102 in front of one his or her eyes. In certain implementations, the eye may be an impaired eye and the patient 52 may hold the display device 102 within a region of his or her existing vision. In certain instances, the region corresponds to an area in which the patient 52 retains peripheral vision and in which the patient 52 may be able to identify movement or the like displayed on the screen 107 of the display device 102. During this process, the patient 52 may be instructed to view into the screen 107 of the VFE system 100 while the imaging device 150 is aimed at objects located outside of the patient's normal field of vision. The patient 52 may then be instructed to physically look away from the screen 107 and turn their head and gaze to the true object location. This is repeated as many times as necessary for the patient 52 to become comfortable with the process of moving between viewing an image on the screen 107 and turning towards area within the image.

At operation 908, proper positioning and orientation of the imaging device 108 is determined. In general, the process of determining the position and orientation of the imaging device 108 includes identifying the region of lost or impaired vision of the patient 52. In certain implementations, such analysis may be performed prior to introduction of the VFE system 100 as part of the patient's broader clinical treatment. Alternatively, the area of lost or impaired vision may be identified in various ways. For example, in one instance, the patient 52 maintain a forward gaze and the physician or therapist may move an object from outside what would be the unimpaired region of the patient's vision into the unimpaired region. The patient may then notify when the object enters his or her vision. This process may be repeated to map out the area corresponding to the patient's impaired vision. The imaging device 108 may then be positioned relative to the patient 52 to capture the identified area.

At operation 910, the imaging device 108 is fixed relative to the patient 52 such that the imaging device 108 maintains the position and orientation identified during operation 908. In certain implementations, fixing the imaging device 108 may include coupling the imaging device 108 to the patient, a garment or accessory worn by the patient 52, or a piece of furniture or conveyance (such as a wheelchair) used by the patient 52.

After coupling of the imaging device 108, the patient 52 may then be instructed to briefly glance down into the screen 107 of the display device 102 (e.g., for two seconds initially and then reducing to one second) to begin developing awareness of what can be seen on the screen 107. Training of the patient 52 to scan the screen 107 in such a manner may be practiced as many times as necessary for the patient 52 to begin to display competence in identifying objects displayed on the screen 107 and to develop spatial awareness regarding the area of lost or impaired vision. When the patient 52 has developed sufficient awareness and familiarity with the VFE system 100, the patient 52 may then be instructed to go for a walk or perform a similar task while being assisted by another person who will walk or otherwise be alongside the patient 52 and within the patient's normal field of vision. Such tasks may be performed multiple times indoors and outdoors and in various other conditions to help increase the patient's proficiency with the VFE system 100.

After initial setup and calibration of the VFE system 100 and development by the patient 52 of a base proficiency with the VFE system 100, a subsequent examination may be conducted to determine the increase in useable field of view provided by the VFE system 100. In an example of such an examination, the patient 52 is seated in an exam room and positioned a predetermined distance, such as 2 meters, from each of the front of the room and a side of the room corresponding to the region of impaired or lost vision. Visual stimuli of varying shapes and sizes are placed around the room in a manner such that the patient is unable to see the stimulation prior to initiating the examination. Examples of visual stimuli may include, without limitation, one or more of cards from a deck of playing cards, 5×7 photos, 8.5×11 pictures, and similar objects. The visual stimuli are randomly placed with a first set of the stimuli being positioned on the front wall and a second set being positioned on the side wall. The patient is monitored by an examiner and maintains a forward head position. The patient is then permitted to gaze down into the screen 107 of the VFE system 100 to identify as many of the visual stimuli as possible within a predetermined time period. An examiner may tally a score and check for accuracy and the tally may correspond to the static increase in patient's useable field of view.

In another examples examination (which may be conducted in conjunction with the foregoing examination), the patient 52 is placed within an examination room except the front and side walls are blank white, or off-white. The patient 55 is then instructed to start with forward gaze and is monitored by an examiner to maintain the forward gaze. Following initiation of the test, the patient is given two tasks. First, the patient is to periodically and briefly scan into the screen 107 of the VFE system 100 (e.g. every five seconds for no longer than one second). Second, the patient is to attempt to be identify motion in the screen 107 and have such motion cue the patient to scan the screen 107. A second examiner then uses a wand with a black sphere or similar object on its end and randomly brings the black sphere into the patient's reduced or lost visual field. In certain implementations, for example, the wand may be a two meter wand with a black sphere having a diameter of approximately 6 cm and the second examiner may move the wand such that the black sphere moves into the reduced or lost visual field at a velocity of 0.5 meters per second and up and down within the lost visual field (e.g., 0.5 meters up followed by 0.5 meters down) at a velocity of approximately one meter per second. The patient may then report each time the black sphere is seen. After each time the patient sees the black sphere, it is removed from the field of view and presented likewise from a new position. This is repeated for multiple trials (e.g., 20 trials) to measure the dynamic increase in the patient's useable field of view.

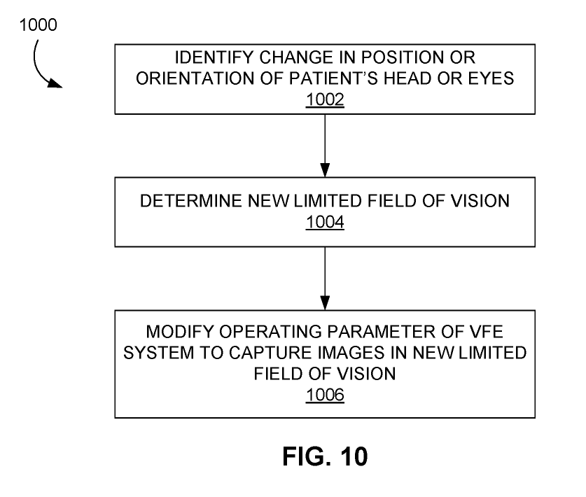

FIG. 10 is a flow chart illustrating a method 1000 for controlling the VFE system 100 to account for movement of the patient 52. More specifically, the method 1000 is directed to adjusting the imaging device 150 of the VFE system 100 to account for movement by the patient 52 such that the imaging device 150 continues to capture images within a limited portion of the patient's field of vision despite movement by the patient 52.

At operation 1002, the VFE system 100 identifies a change in the position or orientation of the patient's head and/or the direction of the patient's gaze. Referring to FIGS. 6A and 6B and the accompanying description, for example, such a change may be identified based on, among other things, measurements obtained from one or more sensors adapted to measure movement of the patient's head and/or movement of the patient's gaze.

At operation 1004, a new limited field of vision is determined. In certain implementations, a patient, physician, therapist, or other person involved in treatment of the patient may provide the VFE system 100 with data describing the patient's vision limitations. Such data may include, without limitation, data describing regions of the patient's field of view and the degree to which such regions are impaired. For example, in one implementation, the data may include an angle relative to the patient's primary gaze corresponding to an impaired region.

Based on the data, the VFE system 100 may recalculate a new limited field of vision. For example, if the data indicates that a patient has impaired vision using his or her right eye within a 15 degree arc and the VFE system 100 detects that the patient has moved his or her head 20 degrees to the left relative to the imaging device of the VFE system 100, the VFE system 100 may determine the patient's new limited field of vision has similarly shifted 20 degrees to the left.

At operation 1006, an operating parameter of the VFE system 100 is modified such that an imaging device of the VFE system 100 captures images of the new limited field of vision. As previously described in the context of FIGS. 6A-6B, the VFE system 100 may adjust the area for which images are being captured in various ways. In certain implementations, the VFE system 100 may include multiple imaging devices and may switch between receiving image feeds from different imaging devices in order to capture the new limited field of vision. In other implementations, the VFE system 100 may present a specific portion of an image captured by one of the imaging devices. For example, an imaging device may capture wide angle images and different portions of the wide angle images may be presented based on the current limited field of vision.

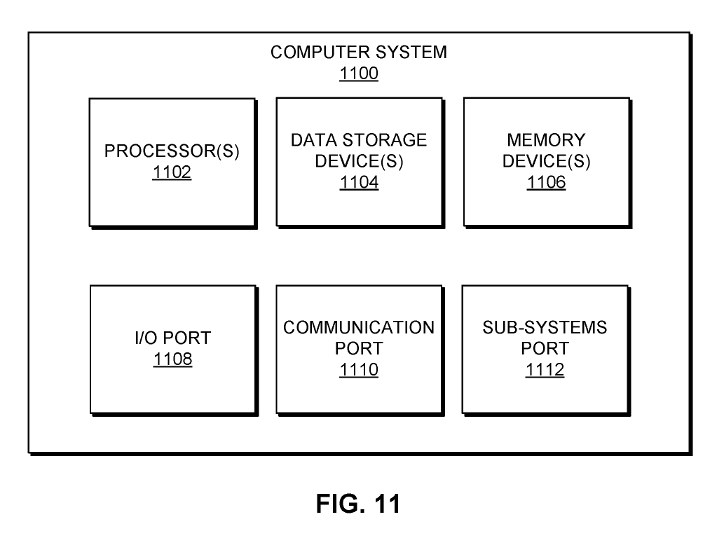

Referring to FIG. 11, a schematic illustration of an example computing system 1100 having one or more computing units that may implement various systems and methods discussed herein is provided. It will be appreciated that specific implementations of these devices may be of differing possible specific computing architectures not all of which are specifically discussed herein but will be understood by those of ordinary skill in the art. In implementations of the present disclosure, the computing system 1100 may correspond to, among other things, the display device 102, the imaging device 150, a combined device including each of the display device 102 and the imaging device 150, and computing devices incorporating the display device 102 and/or the imaging device 150.

The computer system 1100 may be a computing system capable of executing a computer program product to execute a computer process. Data and program files may be input to computer system 1100, which reads the files and executes the programs therein. Some of the elements of the computer system 1100 are shown in FIG. 11, including one or more hardware processors 1102, one or more data storage devices 1104, one or more memory devices 1108, and/or one or more ports 1108-1112. Additionally, other elements that will be recognized by those skilled in the art may be included in the computing system 1100 but are not explicitly depicted in FIG. 11 or discussed further herein. Various elements of the computer system 1100 may communicate with one another by way of one or more communication buses, point-to-point communication paths, or other communication means not explicitly depicted in FIG. 11.

The processor 1102 may include, for example, a central processing unit (CPU), a microprocessor, a microcontroller, a digital signal processor (DSP), and/or one or more internal levels of cache. There may be one or more processors 1102, such that the processor 1102 comprises a single central-processing unit, or a plurality of processing units capable of executing instructions and performing operations in parallel with each other, commonly referred to as a parallel processing environment.

The computer system 1100 may be a conventional computer, a distributed computer, or any other type of computer, such as one or more external computers made available via a cloud computing architecture. The presently described technology is optionally implemented in software stored on data storage device(s) 1104, stored on memory device(s) 1106, and/or communicated via one or more of the ports 1108-1112, thereby transforming the computer system 1100 in FIG. 11 to a special purpose machine for implementing the operations described herein. Examples of the computer system 1100 include personal computers, terminals, workstations, mobile phones, tablets, laptops, personal computers, multimedia consoles, gaming consoles, set top boxes, and the like.

One or more data storage devices 1104 may include any non-volatile data storage device capable of storing data generated or employed within the computing system 1100, such as computer executable instructions for performing a computer process, which may include instructions of both application programs and an operating system (OS) that manages the various components of the computing system 1100. Data storage devices 1104 may include, without limitation, magnetic disk drives, optical disk drives, solid state drives (SSDs), flash drives, and the like. Data storage devices 1104 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. One or more memory devices 1106 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1104 and/or the memory devices 1106, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1100 includes one or more ports, such as an input/output (I/O) port 1108, a communication port 1110, and a sub-systems port 1112, for communicating with other computing, network, or vehicle devices. It will be appreciated that the ports 1108-1112 may be combined or separate and that more or fewer ports may be included in the computer system 1100.

The I/O port 1108 may be connected to an I/O device, or other device, by which information is input to or output from the computing system 1100. Such I/O devices may include, without limitation, one or more input devices, output devices, and/or environment transducer devices/sensors.

In one implementation, the input devices convert a human-generated signal, such as, human voice, physical movement, physical touch or pressure, and/or the like, into electrical signals as input data into the computing system 1100 via the I/O port 1108. Similarly, the output devices may convert electrical signals received from the computing system 1100 via the I/O port 1108 into signals that may be sensed as output by a human, such as sound, light, and/or touch. The input device may be an alphanumeric input device, including alphanumeric and other keys for communicating information and/or command selections to the processor 1102 via the I/O port 1108. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 1100 via the I/O port 1108. For example, an electrical signal generated within the computing system 1100 may be converted to another type of signal, and/or vice-versa. In one implementation, the environment transducer devices sense characteristics or aspects of an environment local to or remote from the computing device 1100, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example the computing device 1100, such as, physical movement of some object (e.g., a mechanical actuator), heating or cooling of a substance, adding a chemical substance, and/or the like.

In one implementation, a communication port 1110 is connected to a network by way of which the computer system 1100 may receive network data useful in executing the methods and systems set out herein as well as transmitting information and network configuration changes determined thereby. Stated differently, the communication port 1110 connects the computer system 1100 to one or more communication interface devices configured to transmit and/or receive information between the computing system 1100 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via communication port 1110 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 1110 may communicate with an antenna for electromagnetic signal transmission and/or reception.

The computer system 1100 may include a sub-systems port 1112 for communicating with one or more external systems. Such systems may include, but are not limited to imaging systems, radar, lidar, motor controllers and systems, and battery controls. For example, such sub-systems may be part of a vehicle that includes one or more of hybrid or electric motor systems, autonomous or semi-autonomous processors and controllers, steering systems, brake systems, light systems, navigation systems, environment controls, entertainment systems, and the like.

The system set forth in FIG. 11 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended thereto.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

What is claimed is:

1. A method of treating a visual limitation of a patient, the patient having an eye and a field of vision, the method comprising:
capturing images of a region that would not be readily viewable by the patient due to at least one of a visual or physical impairment of the patient, the images being captured via an imaging device supported in proximity to the patient; and
transmitting the images to a wearable screen positioned in front of the eye of the patient such that the patient can view the captured images on the wearable screen with the eye.

2. The method of claim 1, further comprising coupling the wearable screen to at least one of a pair of eyeglasses or headwear such that the wearable screen is disposed within a peripheral region of the patient's field of vision.

3. The method of claim 1, further comprising coupling the imaging device to at least one of the patient, a garment or accessory worn by the patient, or an object in proximity to the patient such that the imaging device is directed towards the region that would not be readily viewable by the patient.

4. The method of claim 1, further comprising electrically coupling the imaging device to the wearable screen.

5. The method of claim 1, further comprising displaying the images within a peripheral region of the patient's field of vision using the wearable screen.

6. The method of claim 1, further comprising:
identifying a modification to the region not readily viewable by the patient resulting in a modified region;
capturing second images including the modified region; and
transmitting the images to the wearable screen such that the patient can view the modified images on the wearable screen with the eye.

7. The method of claim 6, wherein identifying the modification to the region includes identifying at least one of an eye movement or a head movement of the patient.

8. The method of claim 6, wherein the imaging device is configured to capture images of each of the region and the modified region and the second images are captured using the imaging device.

9. The method of claim 6, wherein the second images are captured using a second imaging device supported in proximity to the patient.

10. The method of claim 1, further comprising:
detecting an object within the region that would not be readily viewable by the patient; and
issuing a warning to the patient in response to detecting the object.

11. The method of claim 10, wherein the warning includes at least one of an audible warning, a visual warning displayed on the wearable screen, or a tactile warning.

12. The method of claim 1, wherein the imaging device is one of a smartphone device and a live-streaming video device.

13. A kit for providing images for visual field enhancement to an eye of a patient, the kit comprising:
a wearable screen configured to be worn by the patient and to be positioned in front of the eye of the patient such that the patient can view the wearable screen with the eye; and
instructions directed to configuration and calibration of the wearable screen, the instructions directing:
(1) the wearable screen to be positioned within a peripheral region of a field of view of the patient; and
(2) an imaging device to be connected to the wearable screen and directed to a region that would not be readily viewable by the patient due to at least one of a visual or physical impairment of the patient.

14. The kit of claim 13 further comprising the imaging device.

15. The kit of claim 13, wherein the instructions are at least one of printed instructions included with the kit, electronic instructions stored within a memory of the wearable screen, or electronic instructions available for download over a network.

16. The kit of claim 13, the instructions further directing the wearable screen to be coupled to at least one of the patient, a garment worn by the patient, or an accessory worn by the patient.

17. A visual field enhancement system for an eye of a patient, the system comprising:
a wearable screen configured to be worn by the patient and positioned in front of the eye of the patient such that the patient can view the wearable screen with the eye; and
an imaging device electrically coupled to the video screen,
wherein the imaging device can be oriented to capture images of a region that would not be readily viewable by the patient due to at least one of a visual or physical impairment of the patient, the captured images of the region being transmitted to the video screen, the video screen being positioned in front of the eye of the patient such that the patient can see the captured images on the video screen.

18. The system of claim 1 further comprising a mount coupled to the wearable screen, the mount adapted to couple the wearable screen to at least one of the patient, a garment worn by the patient, or an accessory worn by the patient.

19. The system of claim 1 further comprising an imaging device mount coupled to the imaging device, the imaging device mount for mounting the imaging device in proximity to the patient.

20. The system of claim 1, wherein the wearable screen and the imaging device are integrated into a single assembly.
